(19) United States
(12) Patent Application Publication
(10) Pub. No.: US 2013/0341421 A1
(43) Pub. Date: Dec. 26, 2013

(54) FUEL INJECTOR

(71) Applicants: Martin MUELLER, Moeglingen (DE); Tilo LANDENFELD, Vaihingen/Enz (DE); Ulrich DOEBLER, Schwieberdingen (DE); Cornelia GIESSLER, Beilstein (DE); Michael GEIGER, Stuttgart (DE)

(72) Inventors: Martin MUELLER, Moeglingen (DE); Tilo LANDENFELD, Vaihingen/Enz (DE); Ulrich DOEBLER, Schwieberdingen (DE); Cornelia GIESSLER, Beilstein (DE); Michael GEIGER, Stuttgart (DE)

(73) Assignee: Robert Bosch GmbH, Stuttgart (DE)

(21) Appl. No.: 13/917,361

(22) Filed: Jun. 13, 2013

(30) Foreign Application Priority Data
Jun. 15, 2012 (DE) 10 2012 210 134.9

(51) Int. Cl. F02M 51/06

(52) U.S. Cl. CPC F02M 51/0603
USPC 239/5; 239/584

(57) ABSTRACT

A fuel injector, in particular for direct injection of fuel into a combustion chamber, including a housing having one combustion-chamber side injection aperture, a valve needle which is linearly movable in the housing and outwardly opening for opening and closing the injection aperture, a piezoelectric actuator for moving the valve needle, a first stop surface on the valve needle facing the combustion chamber, and a second stop surface on the housing diametrically opposed to the first stop surface. The first stop surface makes an impact on the second stop surface in the case of a maximally possible movement of the valve needle in the direction of opening with the aid of the piezoelectric actuator.

### FIELD OF THE INVENTION

The present invention relates to a fuel injector having an outwardly opening valve needle and a piezoelectric actuator for moving the valve needle. Furthermore, the present invention relates to a method for operating the fuel injector.

### BACKGROUND INFORMATION

In particular, in the area of direct injection of fuel, for example, for motor vehicle engines, valves are used, the valve needle of which is moved by a piezoelectric actuator against a closing spring in such a way that a desired quantity of fuel per unit of time may be specifically introduced directly into the combustion chamber. Of interest in the present case are injectors whose valve needles are moved using a piezoelectric actuator. A very precise and rapid movement is possible with the aid of the piezoelectric actuator. Furthermore, consideration will be given to outwardly opening valve needles. “Outwardly opening” means that the valve needle is moved in the direction of the combustion chamber for opening the injector. An advantage of the outwardly opening valve needles is that the lift of the valve needle may be continuously adjusted. The piezoelectric actuator is activated using an electrical control variable (for example, a charge or a voltage) ascertained individually for each injector, in such a way that a desired nominal lift is set and accordingly the desired quantity of fuel for normal operation is predefined. As a result of, for example, wear and change of the actuator lift during operation, the lift of the valve needle or the lift integral are also changed. Consequently, the quantity of fuel supplied to the combustion chamber per unit of time is changed. The change of the lift of the valve needle is among other things characterized by a change in the average nominal lift (also: lift plateau), or by the shape of the needle lift curve over time (for example, delay time and lift gradient). The occurrence of the needle lift change and the period of operation and operating conditions required for this are individual for each valve and thus cannot be determined empirically with sufficient accuracy. In the related art, the change in lift and the associated flow change are determined in the engine by the cylinder-individual torque of the internal combustion engine or by the lambda value. Additional defined operating points must be run for both methods. However, these result in an increase in exhaust gas and fuel consumption values. Furthermore, the accuracy of the known methods is about 5% due to the determination of indirect control variables.

### SUMMARY

The fuel injector according to the present invention now makes it possible to adjust the lift of the piezoelectric actuator or of the valve needle based on a direct control variable for the needle lift change. The direct detection of the impact of a first stop surface on a second stop surface makes it possible to detect the needle lift change at its point of origin and adjust it for each individual valve. Furthermore, partial lifts are not limited by the impact. These advantages are achieved by a fuel injector including a housing having a combustion-chamber side injection aperture and a linearly movable, outwardly opening valve needle in the housing for opening and closing the injection aperture. Furthermore, the fuel injector includes a piezoelectric actuator for moving the valve needle. Appropriate piezo elements are situated in the piezoelectric actuator, which are energized for moving the valve needle. According to the present invention, a first stop surface is formed on the valve needle. This first stop surface faces the combustion chamber. A second stop surface on the housing is diametrically opposed to the first stop surface. The piezoelectric actuator is designed in such a way that the first stop surface makes an impact on the second stop surface in the case of a maximally possible movement of the valve needle in the direction of opening with the aid of the piezoelectric actuator. This impact may be read off directly based on the electrical signals of the piezoelectric actuator. During operation of the fuel injector, the piezoelectric actuator is activated strongly enough at regular intervals that the first stop makes an impact on the second stop. Based on the detected impact, it is then possible to set the lift of the valve needle for normal operation.

A gap is preferably set between the first stop surface and the second stop surface in such a way that the first stop surface does not make an impact on the second stop surface when the injector is operated normally. It thus continues to be possible to utilize the advantages of a fuel injector having an outwardly opening valve needle and a piezoelectric actuator. The piezoelectric actuator makes it possible to move the valve needle extremely rapidly and precisely. During normal operation, the opening movement of the valve needle may be adjusted continuously and without impact in order to make any desired injection quantity possible.

The first stop surface and/or the second stop surface are preferably designed as a spring-loaded lift stop for reducing momentum peaks and accordingly for reducing the wear of the stop surfaces. For this purpose, a spring, in particular a coil spring, is situated between the first stop surface and a fixed point on the valve needle. Additionally or alternatively, a spring may also be situated between the second stop surface and a fixed point on the housing.

A ring is preferably attached on the valve needle for forming the first stop surface. If the above-described spring is used, the ring is movable along the longitudinal axis of the valve needle. If a fixed first stop surface is formed, the ring is in particular integrally joined with or force-fit to the valve needle. The stop is attached as close as possible to the valve seat or the injection aperture in order to compensate for all influencing factors as much as possible. For preventing wear, the two stop surfaces are preferably designed to be very hard. For example, hardened steel is used for this purpose. Furthermore, a surface coating is possible to increase the surface hardness and reduce wear. The two stop surfaces or the ring on the valve needle are designed in such a way that the fuel may flow past the two stop faces even in the case of an impact.

Furthermore, a control unit for activating the piezoelectric actuator is preferably provided. The control unit is designed to detect an impact of the first stop surface on the second stop surface based on an electrical signal on the piezoelectric actuator.

The current and/or charge and/or the voltage on the piezoelectric actuator may be used in particular as electrical signals for detecting the impact.

It is particularly preferred that the control unit measures the time from an energization or an activation of the piezoelectric actuator until the impact. Based on the time, it is possible to adjust the lift of the valve needle for normal operation.

The present invention further includes a method for operating a fuel injector. The advantageous embodiments described in connection with the fuel injector according to the present invention accordingly are advantageously applied to the method according to the present invention. The method according to the present invention includes the following steps: (i) providing a fuel injector having a housing, an outwardly opening valve needle and a piezoelectric actuator for activating the valve needle, a first stop surface being formed on the valve needle and a second stop surface being formed on the housing, (ii) energizing the piezoelectric actuator for moving the valve needle, (iii) detecting an impact of the first stop surface on the second stop surface based on at least one electrical signal on the piezoelectric actuator, and (iv) setting a lift of the valve needle based on the detected impact. The time or lift until impact is detected injector-individually in the new condition and this information is transferred to the control unit.

It is preferably provided that the first stop surface does not make an impact on the second stop surface when the fuel injector is operated normally. Only for adjusting the lift is the valve needle moved far enough that it makes an impact.

In the new condition, each fuel injector is operated with the aid of a control variable which is ascertained individually for each injector, so that the lift impact is achieved reliably. The time span between the beginning of the actuator energization and making the impact is ascertained and transferred to the control unit. In combination with this, the needle lift or the electrical control variable may also be detected until the impact is made and this information is transferred to the control unit. This results in an individual value for the fuel injector in the new condition. After the fuel injector has been used in an engine for a certain time, the engine is operated at a determined operating point, and the piezoelectric actuator is reactivated in such a way that an impact is made. The values ascertained in this manner may be compared with the values from the new condition. The changes are subsequently determined for each fuel injector and converted into an effective needle lift change. In order to regulate this needle lift change, the required electrical variable for the piezoelectric actuator, or alternatively, the duration of injection, may be adjusted.

The check of the values needs to be ascertained in a motor vehicle only rarely, for example, every thousand kilometers. This ensures that the stop surfaces do not wear out, the travel to reach the impact remains constant over the service life and accordingly the accuracy of the re-adjustment is ensured.

### BRIEF DESCRIPTION OF THE DRAWINGS

FIG. 1 shows a fuel injector according to the present invention according to a first exemplary embodiment, and

FIG. 2 shows a fuel injector according to the present invention according to a second exemplary embodiment.

### DETAILED DESCRIPTION

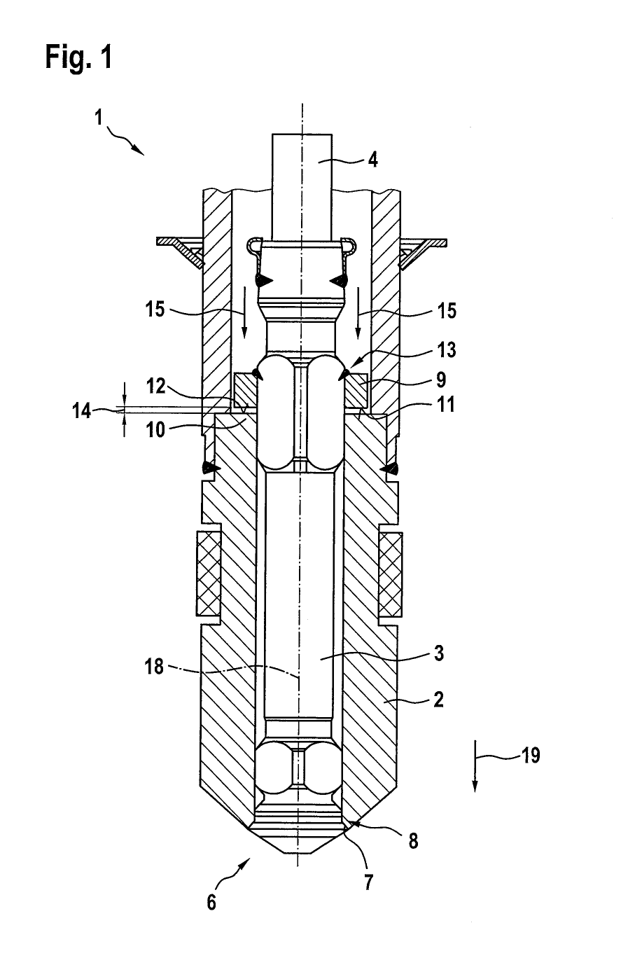

FIG. 1 shows a fuel injector 1 according to the first exemplary embodiment. Fuel injector 1 includes a housing 2. In housing 2, a valve needle 3 is guided longitudinally movably along a longitudinal axis 18. On a side facing combustion chamber 6, an injection aperture 7 is formed in housing 2. On a side facing away from the combustion chamber, a piezoelectric actuator 4 is situated for moving valve needle 3 along longitudinal axis 18. FIG. 1 shows the closed state of fuel injector 1. In this state, valve needle 3 forms a sealing seat 8 with injection aperture 7. During an appropriate energization of piezoelectric actuator 4, valve needle 3 is moved in the indicated direction of opening 19. This causes injection aperture 7 to open and fuel is able to flow through the interior of housing 2 along indicated direction of flow 15 and enter the combustion chamber directly via injection aperture 7.

A ring 9 is attached to valve needle 3, the ring being joined to valve needle 3 via an integral connection 13, for example, a weld seam. On the side of ring 9 facing the combustion chamber, a first stop surface 11 is formed. A shoulder 10 is formed in housing 2. A second stop surface 12 is provided on shoulder 10 diametrically opposed to first stop surface 11. A gap 14 is provided between the two stop surfaces 11, 12. Gap 14 is selected to be large enough that during normal operation of fuel injector 1, first stop surface 11 does not come into contact with second stop surface 12. Only for checking and adjusting the lift of valve needle 3 is piezoelectric actuator 4 energized in such a way that first stop surface 11 makes an impact on second stop surface 12.

With the aid of an appropriate control unit, piezoelectric actuator 4 may be activated to trigger the impact. Based on an appropriate signal on piezoelectric actuator 4, the exact point in time of the impact is detected. This is possible since the momentum occurring as a result of the impact continues into the piezoelectric actuator and is detectable in the piezoelectric actuator due to the electrical signals, for example, based on a change of gradient.

According to the present invention, a possibility is thus provided for setting the lift of valve needle 3 with the aid of a directly ascertained control variable and thus compensating for wear. At the same time, the advantages of the outwardly opening valve needle and the piezoelectric actuator may be utilized according to the present invention.

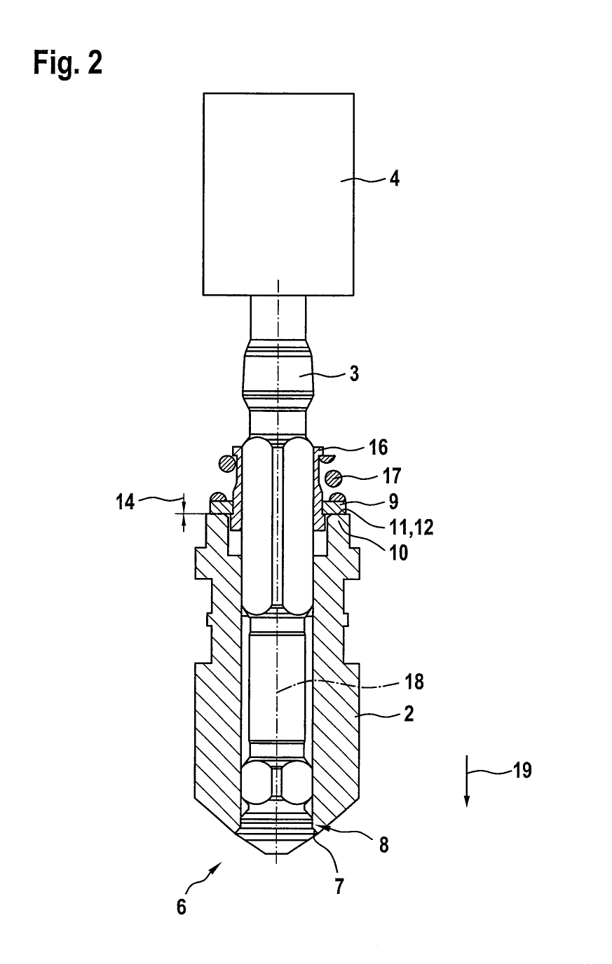

FIG. 2 shows fuel injector 1 according to a second exemplary embodiment. Identical or functionally identical components are provided with the same reference numerals in all exemplary embodiments. For the sake of clarity, a portion of housing 2 is hidden in the second exemplary embodiment.

In the second exemplary embodiment, a sleeve 16 is fixedly mounted on valve needle 3. Ring 9 is displaceably situated on valve needle 3 along longitudinal axis 18. Between a shoulder on sleeve 16 and ring 9 a spring 17 is inserted. One end of spring 17 thus rests against a stationary point with respect to valve needle 3. The other end of spring 17 rests against movable ring 9.

In the second exemplary embodiment, the impact between the two stop surfaces 11, 12 is dampened by spring 17. This reduces the wear on stop surfaces 11, 12 and the load on entire fuel injector 1 caused by the momentum is reduced.

What is claimed is:

1. A fuel injector, comprising:
a housing including a combustion-chamber side injection aperture;
a linearly movable, outwardly opening valve needle in the housing and for opening and closing the injection aperture;
a piezoelectric actuator for moving the valve needle, wherein the valve needle includes a first stop surface facing a combustion chamber; and
a second stop surface on the housing and diametrically opposed to the first stop surface, wherein the first stop surface is adapted to make an impact on the second stop surface in the case of a maximally possible movement of the valve needle in a direction of an opening with the aid of the piezoelectric actuator.

2. The fuel injector as recited in claim 1, wherein a gap is set between the first stop surface and the second stop surface in such a way that the first stop surface does not make an impact on the second stop surface when the fuel injector is operated normally.

3. The fuel injector as recited in claim 1, further comprising at least one of:
a spring between the first stop surface and the valve needle; and
an additional spring between the second stop surface and the housing.

4. The fuel injector as recited in claim 1, wherein at least one of:
the first stop surface is formed on a ring attached to the valve needle, and
the second stop surface is formed on a shoulder in the housing.

5. The fuel injector as recited in claim 1, further comprising:
a control unit for activating the piezoelectric actuator, wherein the control unit detects the impact of the first stop surface on the second stop surface based on an electrical signal of the piezoelectric actuator.

6. The fuel injector as recited in claim 5, wherein the electrical signal represents at least one of a charge, a current, and a voltage of the piezoelectric actuator.

7. The fuel injector as recited in claim 5, wherein the control unit ascertains a time from an energization of the piezoelectric actuator until the impact.

8. The fuel injector as recited in claim 7, wherein the control unit adjusts a lift of the valve needle based on the ascertained time.

9. The fuel injector as recited in claim 1, wherein the fuel injector is for a direct injection of a fuel into the combustion chamber.

10. A method for operating a fuel injector having a housing, an outwardly opening valve needle, and a piezoelectric actuator for activating the valve needle, comprising:
energizing the piezoelectric actuator;
detecting an impact of a first stop surface of the valve needle on a second stop surface of the housing based on at least one electrical signal of the piezoelectric actuator; and
setting a lift of the valve needle based on the detected impact during operation and in a new condition.

11. The method as recited in claim 10, wherein the first stop surface does not make an impact on the second stop surface when the fuel injector is operated normally.
